(19) United States
(12) Patent Application Publication
(10) Pub. No.: US 2010/0046732 A1
(43) Pub. Date: Feb. 25, 2010

(54) INDUCING B-PARTY DEFINED BEHAVIOURS IN A-PARTY COMMUNICATIONS BY DISTRIBUTION OF USER INTERFACES

(76) Inventors: Robert Geoffrey James, Victoria (AU); Peter Gerald Donnelly, Victoria (AU); Mark William Michell, Victoria (AU)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/447,568

(22) PCT Filed: Oct. 31, 2007
(86) PCT No.: PCT/AU07/01646

§ 371 Date: Sep. 15, 2009

(30) Foreign Application Priority Data
Oct. 31, 2006 (AU) 2006906055

(51) Int. Cl. H04M 3/42; H04L 12/66; H04W 4/14

(52) U.S. Cl. 379/211.01; 370/352; 455/466

(57) ABSTRACT

A method for inducing B-party defined behaviour in an A-party communications end-point (5), the method including the steps of receiving a user interface (71) at the A-party communications end-point, the user interface being associated with at least one B-party user or communications service and encoding one or more B-party defined or selected behaviours; invoking the user interface at the A-party communications end-point in response to at least one trigger; and interpreting the user interface at the A-party communications end-point to induce a resultant behaviour.

### FIELD OF INVENTION

The present invention relates to a method and system for a first user to establish a user interface which is utilized so as to express a desired behaviour in association with communications or calls from others to the first user. The present invention relates particularly, but not exclusively, to a method and system wherein a user interface which encodes a desired behaviour is established by a first user and communicated to an end-point of a second user such as a mobile handset and invoked on the end-point in association with an outbound communication from the second end-point such as a phone call, and perhaps at other times, so as to express a resultant behaviour on the second user's end-point, which resultant behaviour accords in at least some respect with the encoded desired behaviour established by the first user.

### BACKGROUND ART

PSTN and PLMN based telephone networks make use of sounds during call establishment to provide A parties with certain information about a B party's status, such as that a B party's phone is alerting or that the a B party's phone is “off-hook” or “busy”. While such a feedback mechanism is essential for any practical telephone service, the amount of information conveyed is highly constrained, and further a B party has no direct control over which information will be provided to an A party nor in how the information will be presented to an A party.

Telephone services also frequently allow a subscriber to have a level of control over the way incoming calls are handled. For example, PSTN and PLMN based telephone services often allow a subscriber to divert incoming calls to voice mail or to a third telephone service in certain circumstances (for example ‘CFB’—line busy or ‘CFNR’—ring out), or else for a period determined by the subscriber (for example ‘CFU’—call forward unconditional). While highly useful, these features are very limited and fully determined by the network operator.

Interactive Voice Response (‘IVR’) systems and Voice Recognition (‘VR’) systems are widely used by businesses, either alone or in conjunction with Computer Telephony Integration (‘CTI’) systems to answer, filter, categorize and route calls, and sometimes even completely handle simple transactions such as enquiries or bill payments.

Whilst these systems have proven highly valuable to businesses, IVR and VR systems primarily cater for the needs of the businesses that are called rather than those who call them. Further, it appears that the richness and utility of the ‘user interface’ presented to callers by IVR and VR systems is constrained by the need to support simple POTS telephone handsets where the only available input options are speech and DTMF tones and the only available output option is audio. Further, the constraints referred to are such that existing customers are often required by IVR and VR systems to re-establish their credentials each time they call as if they were a stranger to the business—for example, by continually having to re-enter identification or account number. Further, while some IVR and VR systems offer callers the option to ‘select ahead’, this depends on the caller memorising and recalling a spoken menu hierarchy.

The IETF's Session Initiation Protocol (‘SIP’) and ‘Session Description Protocol’ are service and media agnostic session signalling and description protocols. Among other uses, SIP can be used to bridge ‘old world’ telephony with the ‘new world’ of IP and the Internet. For example the 3GPP's IP Multimedia Sub-system (IMS) is a SIP and DIAMETER based architecture which bridges telephony and IP in a particularly useful way.

Despite the appeal of SIP as a potentially universal protocol for initiating and managing communications sessions comprising arbitrary media types and modalities, and of IMS as a service platform for operator-centric converged communications, it appears that SIP, SDP and IMS are directed towards means of defining, establishing and managing communications sessions for users who are potentially mobile or roaming, and not to the interaction between a calling user and a call.

Instant Messaging (‘IM’) systems, so-called ‘Universal Communications Services’ and some VoIP systems and digital PABXs allow B parties to provide A parties with status, presence and sometimes other information. For example, someone who will be away from their desk for a period may be able to configure their phone so that callers will receive a visual message indicating this while they are away. Similarly, IM systems usually allow a B party to indicate to an A party that they are unavailable, and in turn may offer an A party the opportunity to leave a text or voice message when a B party is showing their status as unavailable.

Whilst useful, the structure and form of the way a B party presents to A parties in such systems is almost entirely determined by the system vendor or operator so that a B party's opportunity to customize the way they present to A parties is highly limited. Further, in such systems a B party is typically unable to present differently to different A parties or classes of A party. Further, where such a system provides A parties with interactive options, the interactive options are fixed and pre-determined by the system rather than the B party. Further, such systems require that both the A party and the B party have specially equipped end-points (which may be software or hardware based or both) designed to work with the system. Further, such systems depend for their operation on the real-time or near real time transfer of call status and control and other information between the B party's end-point and the A party's end-point and depend upon presence information being continually updated at a central server which mediates communications between the parties.

Ringback tones (RBT) systems allow a B party to customize the sound that an A party hears when they call the B party, thereby allowing the B party to exercise a limited form of control over the way they present themselves to calling users. However it appears that because RBT systems are specifically designed to work with unmodified POTS and mobile phone terminals, the only aspect of an A party's experience of a call to a B party which can be customized is the sound played in the A party's handset ear-piece. Further, RBT systems depend on the deployment of (usually extensive and geographically diverse) network based equipment. Further, while many of today's telephone handsets have significant processing power, the ability to present multimedia, colour screens and soft-keys—all of which might be used to allow a B party to customise the way they present to an A party during call establishment—RBT systems are unable to take advantage of any of these available capabilities but instead must confine themselves to customizing the low fidelity sound that a calling user hears during call establishment.

U.S. Pat. No. 7,088,016 entitled “A System and Method for Customising Call Alerts” describes a method and system for enabling an A party caller to select the form and/or nature of an alert used to announce a call to a B party. Systems and methods of this invention enable call initiators to personalise the way their calls are announced to those they call, however the invention is entirely directed towards the manner in which callers present themselves and does not address the manner in which called parties may wish to be presented to those who call them.

There exists a need to provide a system which overcomes at least some of the limitations of existing systems and which in particular takes advantage of the fact that communications end-points such as mobile handsets increasingly have independent processing power, data networking capabilities and frequently also colour screens, speakers and a multimedia capability.

### SUMMARY OF THE INVENTION

One aspect of the invention provides a method for inducing B-party defined behaviour in an A-party communications end-point. The method includes the steps of: receiving a user interface at the A-party communications end-point, the user interface being associated with at least one B-party user or communications service and encoding one or more B-party defined or selected behaviours; invoking the user interface at the A-party communications end-point in response to at least one trigger; and interpreting the user interface at the A-party communications end-point to induce a resultant behaviour.

The B-party user or communications service may include any one or more of the following: a telephone service; a voice over IP service; an Instant Messaging service; a video phone service; and a video-conferencing service.

The A-party communications end-point may be a mobile phone, a fixed network phone, a SIP phone, a VoIP phone, a soft phone, or a PC-based communications client, or an Instant Messaging client.

The trigger may be any one or more of the following: an event associated with an outbound communication or attempted establishment of an outbound communication by the A-party communications end-point; an event which is a precursor event to the establishment or attempted establishment of an outbound communication by the A-party communications end-point; entry of information on a keypad or keyboard of the A-party communications end-point; and entry of one or more than one keystroke in succession on a keypad or keyboard of the A-party communications end-point.

The outbound communication or communication attempt may include any one or more of the following: a telephone call; a voice over Internet Protocol call; a video call; a multi-mode call; an SMS message; an MMS message; an Instant Message; and email.

The outbound communication or communication attempt may, for example, be an outbound communication or communication attempt from the A-party communications end-point to a B-party user or communications service.

Possible events or precursor events may include: the selection of the user interface or of some aspect of the visual manifestation of an interpreted user interface; the initiation of a communication on the A-party communications end-point by depression of the call key or soft key or equivalent action on the A-party communications end-point; the entry of at least part of a telephone number on the A-party communications end-point; the selection of an entry in an address book or call history resident on the A-party communications end-point; and the selection of an entry in a call history resident on the A-party communications end-point.

The resultant behaviour may commence: prior to the establishment of the outbound communication; during the establishment of the outbound communication; during the outbound communication; or following the conclusion of the outbound communication.

The resultant behaviour, having commenced, may persists in one or more examplary embodiments: during part or all of the outbound communication; or beyond the conclusion of the outbound communication.

The method may further include the steps of: storing the user interface at one or more network accessible locations; and communicating the user interface to the A-party communications end-point in response to a stimulus.

The user interface may include more than one part, and the parts may be stored at more than one network accessible location.

The user interface may be: established at one or more of the network accessible locations; or uploaded to one or more of the network accessible locations.

More than one user interface may be associated with the B-party user or communications service and none, one or more than one of the plurality of associated user interfaces may be communicated to a A-party communications end-point for use on the A-party communications end-point according to any one or more of the following: preferences or rules provided by or on behalf of a user, subscriber or controller of the B-party user or communications service; information communicated from the A-party user or communications service or end-point; an identifier or network address or service address or end-point address of the B-party user or communications service; a network address or service address or end-point address of the A-party communications end-point; capabilities of the A-party communications end-point; the current time or date; the geographic location of the A-party communications end-point; and programmed logic.

The user interface may be adapted to be modified, updated or replicated consequential to the interpretation of any one or more of the following: information local to one or more of the network accessible locations; information communicated to one or more of the network accessible locations; information communicated to one or more of the network accessible locations from the A-party communications end-point; information which derives from a previous communication between the A-party communications end-point and the B-party user or communications service; information which is the result of previous communications between a A-party communications end-point and one or more of the network accessible locations; information local to the A-party communications end-point; information communicated to the A-party communications end-point; information communicated to the A-party communications end-point from one or more of the network accessible locations; information which derives from a previous communication between a A-party communications end-point and the B-party user or one or more of the B-party communications services; information which is the result of previous communications between the A-party communications end-point and one or more of the network accessible locations; information local to the A-party communications end-point; information communicated to the A-party communications end-point; information communicated to the A-party communications end-point from one or more of the network accessible locations.

The user interface may be stored on an A-party communications end-point.

The user interface may be stored: in volatile memory; in non-volatile memory; in a database; in a cache or caching system; on a computer storage device; or as one or more computer files.

The user interface may be stored: ephemerally; for a defined period of time or a period of time determined by programmed logic; until such time as a newer version is available; until deleted in accordance with a user action; or indefinitely.

The communicating of the user interface to a A-party communications end-point may use one or more of the following: a data network or communications network or internetwork or the internet; a telephone network or a cellular telephone network; a signalling system of a communications network; and a 3GPP or 3GPP2 IP Multimedia Subsystem.

The communicating of the user interface to a A-party communications end-point may make use of: a pre-existing digital path or network connection; or a digital path or network connection established for the purpose.

The user interface may be communicated to the A-party communications end-point: on a single occasion; or over the course of the multiple occasions.

The communicating of the user interface to the A-party communications end-point may occur: as soon as practicable after the occurance of the stimulus; or; at a later time.

The stimulus may originate: on the A-party communications end-point; or at one or more of the network accessible locations.

The stimulus may be: the completion of the storing of the user interface at one or more of the network accessible locations; a request from programmed logic on the A-party communications end-point; or invocation of the user interface on the A-party communications end-point.

The request may include information capable of identifying at least one B-party user or communications service or end-point with which the user interface is associated.

The stimulus may be the communication to one or more network accessible location of an event associated with a communication or communication attempt from: the B-party user or communications end-point; the B-party user or communications service to the A-party communications end-point; the A-party user or communications end-point; or the A-party user or communications end-point to the B-party user or communications service.

The communicating of the user interface to the A-party communications end-point may commence during establishment of an outbound communication or communication attempt from the A-party communications end-point and proceed in real-time. The user interface, once completely communicated to the A-party communications end-point, may be immediately invoked and interpreted thereon. Alternatively, a part of the user interface communicated to the A-party communications end-point may be immediately invoked and interpreted thereon.

The communicating of the user interface to the A-party communications end-point may occur following the provision to one or more of the network accessible locations of information sufficient to enable identification of address information to allow communication of the user interface from one or more of the network accessible locations to the A-party communications end-point.

The user interface, prior to invocation, may be retrieved from storage on the A-party communications end-point. The retrieval step may involve a process of searching on the A-party communications end-point for the correct or best or most appropriate best user interface to be used in a particular circumstance or in response to a particular trigger.

The resultant behaviour may occur: on the A-party communications end-point; on a sub-system or associated system of the A-party communications end-point; or at a location other than the A-party communications end-point.

The resultant behaviour may be influenced by interaction between the user interface on the A-party communications end-point and one or more of the following: a user input; one or more locally detectable events or associated parameters; local or remote information or programmed logic; another copy or version of the same user interface; a part of the same user interface located elsewhere; another user interface; an end-point associated with the B-party user; or a communications service associated with the B-party user.

The resultant behaviour may vary depending upon the nature of the trigger which invoked the user interface. The form, nature or duration of the resultant behaviour may vary dynamically in response to changes in call status, line status, end-point, phone, network, signalling events or associated parameters.

The resultant behaviour may include one or more of the following: the presentation of one or more of the plurality of static or dynamic or streaming or interactive media elements; programmed physical movement; establishing an outbound communication; and creating or changing data or information.

The changed data may be: data associated with a personal address book of the A-party communications end-point; or data associated with a call history of the A-party communications end-point.

Another aspect of the invention provides a user interface for inducing B-party defined or selected behaviour in an A-party communications end-point, the user interface being associated with at least one B-party user or communications service and encoding one or more B-party defined behaviours and including one or more software or data objects to cause: invocation of the user interface at the A-party communications end-point in response to one or more triggers; and interpretation of the user interface at the A-party communications end-point to induce a resultant behaviour.

The user interface may include one or more software or data objects.

The association between the user interface and the B-party user or communications service may be encoded within the user interface.

The user interface may be associated with more than one B-party user or communications service.

The user interface may be established for a B-party user or communications service which is not otherwise associated with a user interface.

The user interface may include by means of incorporation, or specifies by means of reference, one or more of the following: static or dynamic or streaming or interactive media objects or software objects; media objects which contain plain or formatted text or audio or visual or video or animated media; computer files or executable or interpretable code or scripts; data which represents logic, rules, preferences or digital rights; data elements which encode the layout or presentation of or control the timing of or behaviour of media objects or software objects; control or data elements which associate media objects with actions or events; and data or code or script which may be of use in presenting the resultant behaviour.

The user interface may encode application specific, generic or default behaviours.

The user interface may be configured to be available for user interactive download via a network or the World Wide Web.

Yet another aspect of the invention provides a system for inducing B-party defined behaviour in an A-party communications end-point, the system including: one or more network accessible entities configured to: store a user interface, the user interface being associated with at least one B-party user or communications service and encoding one or more B-party defined or selected behaviours; and communicate the user interface to the A-party communications end-point; and at least one A-party communications end-point configured to: receive the user interface; invoke the user interface in response to one or more triggers; and interpret the user interface to induce a resultant behaviour.

The A-party communications end-point may be configured to: cache or store user interfaces; retrieve user interfaces; and manage stored or cached user interfaces.

The one or more network accessible entities may store pre-made user interfaces or interface elements for selection and use as, or incorporation into, new user interfaces

In one or more embodiments, user interfaces may be beneficially applied in a variety of scenarios including, inter alia, as a means of call handling in interpersonal communications scenarios; in transactional scenarios wherein a user wishes to accomplish some end (for example: order a pizza) but not necessarily speak with someone; in ‘information’ or ‘offer’ scenarios wherein a user interface is triggered by some local or remote logic or event and used to present information to a user or make an offer or proposal to a user. In the case of inter-personal scenarios, the user interface will frequently be associated with a call or communication. In the case of transactional and information oriented scenarios, invocation of a user interface may or may not allow for or result in the initiation of a call or communication.

As can be seen, the invention will enable participants to achieve their objectives in interacting or communicating or sharing information in a more effective or efficient manner than would otherwise be possible.

### BRIEF DESCRIPTION OF THE DRAWINGS

The invention will hereafter be described in greater detail by reference to the attached drawings which show example forms of the invention. It is to be understood that the particularity of those drawings does not supersede the generality of the above description of the invention.

In the drawings:

FIG. 1 illustrates a functional block diagram of a preferred embodiment of the present invention;

FIG. 2 illustrates what may be seen or heard on a second communications end-point during the operation of the invention in a transactional scenario; and

FIG. 3 illustrates what may be seen or heard on a second communications end-point during the operation of the invention in an inter-personal communications scenario.

### DETAILED DESCRIPTION OF THE DRAWINGS

The method and system of the present invention will now be described in relation to a preferred embodiment. It is to be appreciated that the following description is not to limit the generality of the invention. The preferred embodiment describes the use of the method and system of the present invention to establish and apply user interfaces to communications between participants as well as other features of the invention.

While the communications end-point 5 used by a second user or A-party requires client software 7 to invoke and interpret user interfaces and obtain the objects which define user interfaces, there is no such requirement for a first user or B-party service or communications end-point 52, 53, which may indeed may be an unmodified POTS or PLMN service or handset; or mobile or SIP end-point or PBX or VoIP system.

Further, while the examples show a standard telephone service as the first communications service, the first communications service may equally comprise any system capable of terminating a telephone call or communication such as an IVR or PABX or IP-PBX or SIP or IMS based system; or indeed a network integral system such as an IN or SS7 based system (so that there may or may not be CPE associated with a first communications service.

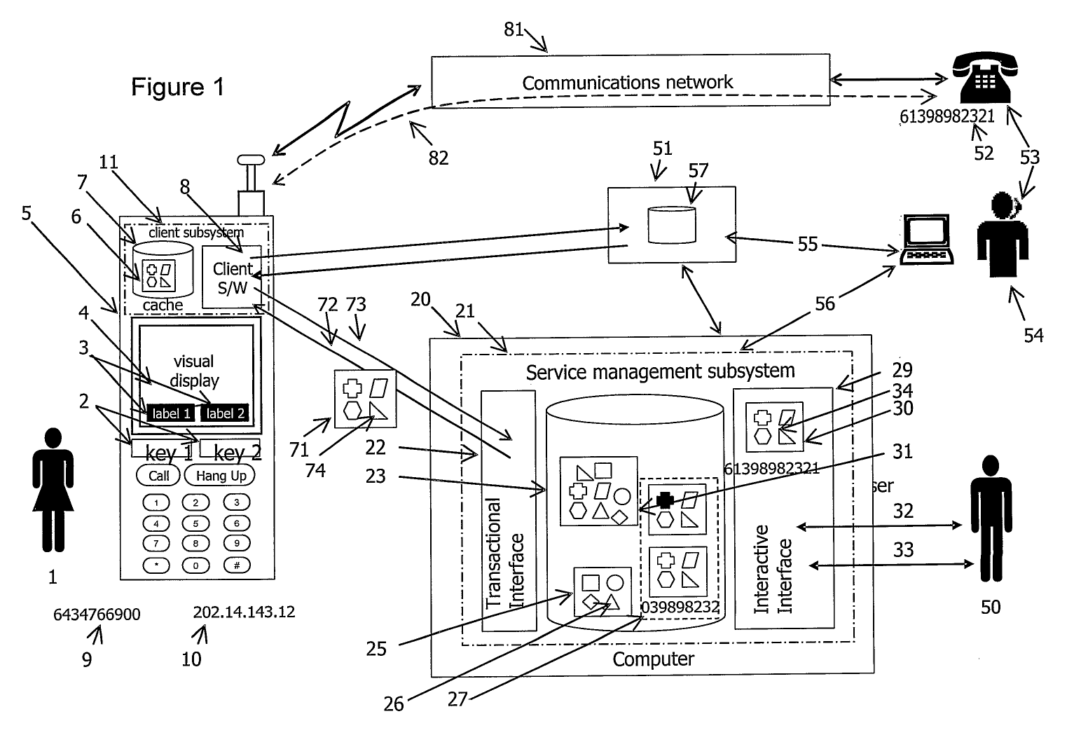

With reference now to FIG. 1, there is illustrated a preferred arrangement of the present invention. In this embodiment a first user 50 is able to establish a user interface 27 and cause the user interface 71 to be communicated to second user's communications end-points such as 5 where it is preferably utilized there to mediate and enhance communications between the second user 1 and the first user 50 and perhaps also utilized there to provide the second user 1 with access to media or information or content which it may contain.

The user interface 27 is preferably composed of one or more software or data objects. The structural or logical representation of a given user interface may change over time or depending its location. For example it may be instantiated as one or more database objects on a server and then be transformed into one or a multiplicity of files or records or packets for convenient transport to a communications end-point where it may subsequently be stored in one or a multiplicity of database objects or files or other kinds of objects or combination thereof.

The user interface preferably contains control information such as logic or conditions or rules or directives or timings which describes how media or other elements it may contain should be utilized by client software on a communications end-point 5, including, preferably, information which describes when the user interface should be invoked and how the media or other elements should or may be used. Another user interface 25 may include by means of incorporation, or specify by means of reference, one or more media elements such as audio or visual or audio-visual or other media elements 26.

A user interface may incorporate interactive elements such as menus or pick-lists or selection buttons or input fields or output boxes which may be used to convey information or allow a user to provide information or indicate preferences or select options. A user interface may cause the establishment of, or influence the course of, or cause the termination of a communication between a second communications end-point 5 and another communications service such as the first communications service 52, 53.

Media elements may be encoded in accordance with any suitable standard such as GIF or JPEG or PNG or MPEG or SVG or BMP or WAV or MIDI or MP3 or MP4 or AVI or AAA or AAC or APC or some other coding standard or method. Control information may be encoded in accordance with some suitable industry or proprietary protocols such as XML or W3C SMIL or Macromedia ‘Lingo’.

Thus it can be seen that a user interface may be very simple, perhaps incorporating just a single visual media element and the implicit rule that the element be presented to a calling user 1 during the course of call establishment of a call 82 from the communications end-points 5 to a first communications service 52; or it may rather be complex and explicit, perhaps allowing for the establishment of a call in certain circumstances, perhaps also involving the presentation of a diverse range of pre-orchestrated or event dependent multimedia elements prior to, during and after the call, if a call is established, and perhaps also incorporating interactive elements such as soft-keys 2,3 or menus to allow the user 1 to make choices which may influence what is presented to them or mediate their interaction with the first user 50 or a call center operator 54 associated with the first user 50 or a networked information source 51 of the first user 50.

The service management sub-system 21 is responsible for server-side aspects of the system. It includes an interactive interface 29 and associated software logic to enable the establishment and management of user interfaces; a data store 23 for storage and retrieval of user interface objects and other objects necessary for the establishment and maintenance of user interface services; a transactional interface 22 and associated software logic for the provision of user interfaces to communications end-points 5; and business logic for the establishment and maintenance of user interface services. It preferably also includes pre-made user interfaces or media elements 31, preferably indexed or catalogued, which may be made available to users such as 50 for selection and use or incorporation into user interfaces such as 30 which they may establish.

The client sub-system 11 is responsible for client-side aspects of the system and includes a means of interacting with and providing data to and retrieving data from a service management sub-system 21; means of activating and presenting user interfaces (either in conjunction with outbound calls or call attempts or otherwise) in accordance with implicit or explicit rules or logic or directives contained within a user interface 6; preferably also includes a non-volatile cache 7 for the storage of user interfaces 6 preferably also includes a means of indexing and storing and managing user interfaces 6 in the cache 7; and preferably also includes a local management interface to enable user 1 management of the client sub-system (for example, the ability to activate or de-activate the client sub-system; restrict the types or kinds or sizes of user interfaces which will be accepted; define users or services from whom user interfaces will or will not be accepted; modify the presentation of user interfaces—for example by suppressing sounds which the user interface might otherwise cause to played).

The client sub-system 11 may beneficially make use of pre-existing capabilities which exist within an communications end-point 5 such as databases or database management systems; ‘personal address book’ or ‘contacts’ management systems; call event management and monitoring systems, perhaps based on TAPI or SIP or SIMPLE or IMS; sub-systems or functions which allow the creation of or management of files or directories or binary or other objects; sub-systems or functions which manage keys, buttons, switches, displays, speakers, vibrators, lights, LEDs or other energy transducers; sub-systems or functions which allow the transfer of data to or from remote computing systems; SMS or MMS or IM or email or other messaging applications or functions; sub-systems or functions which provide access to local external memory or other locally associated systems or sub-systems such as SIMs or USIMs or headsets or remote displays.

A system of the present invention may be equipped with one or more than one interactive interface. An interactive interface 29 may beneficially be implemented as a web application. Interaction between a user 50 and the interactive interface 29 may be supported by means such as an Internet connected personal computer; a data enabled mobile phone or PDA; a DTMF capable phone, SMS or MMS or IM or USSD or email messages or by other suitable means. By way of a first example, the combination of an Internet connected personal computer and a web application based interactive interface 29 will be appropriate for the establishment of a complex or media-rich user interface. In a second example the interactive process may be supported by simpler means such as a DTMF phone or one or a plurality of SMS messages. In this second example the server may make available pre-defined, pre-labelled user interfaces for selection so that establishment of a user interface amounts to a user 50 selecting or providing the label of a pre-defined user interface and defining a first communications service 52, 53 to which the user interface is to be applied (which in some circumstances may be inferred from CLID).

In use, a user 50 provides, by means of an interactive interface 29, information sufficient to enable the establishment a user interface service. In this respect, ‘sufficient information’ means information sufficient to enable the service management sub-system 21 to construct an internal representation of the user interface 30 as software or data objects 34 and associate the user interface with one or more first communications services 52, 53 and store these and other information as may be necessary to define a user interface service for the user 50. In this respect further, the information provided by the user 50 during the interactive process 32 might include media or other elements to be incorporated into the user interface; or information which selects media or other elements to be incorporated into the user interface; or information pertaining to the layout or font or colour or colour scheme or some other aspect of an element or elements of an interpreted user interface 30; or information such as rules or preferences or logic or conditions or event definitions or triggers to be incorporated into the user interface 30 to control the order or timing or some other facet of the behaviour of the user interface 30 when the user interface is subsequently invoked and interpreted.

The interactive process 32 may allow a user 50 to provide or upload a media object or objects (rather than only be able to select from those made available) for inclusion in the user interface 30 or indeed provide or upload a complete user interface wherein the media objects or complete user interface will preferably conform to specifications sufficient for the user interface to operate within a system or systems of the present invention.

Establishment of a user interface service preferably also entails the user 50 providing identification information or credentials. Preferably, the provided identification information or credentials are used by the service management sub-system 21 to validate the identity of the user 50 or establish the scope of the user's 50 rights and capabilities in using the system in respect of the first communications service 52, 53 or services to which the user interface is to be applied.

During and following the interactive process 32, the service management sub-system 21 stores in a database 23 data and associations between data including one or more of: data which constitutes or when appropriately interpreted defines or describes one or more user interfaces 50; data which is capable of identifying one or more communications service such as the first communications service 52,53; data which associates a user interface 30 with one or more communications service such as the first communications service 52, 53; data which identifies a user 50 or using entity 50; data which associates a user interface service with a user or using entity such as 50. In this respect, the stored data is sufficient to enable the service management sub-system 21 to perform necessary future user interface service related functions including, inter-alia, allowing a user 50 to manage their user interface service and providing user interfaces to communications end-points such as 1.

Depending on the design objectives of the system, the service management sub-system 21 may store user interfaces in an internal or canonical form which may require subsequent modification prior to being sent to a communications end-point 5 of a particular type or category; or it may store multiple versions of a user interface 25, 26 wherein the format of each version is suited to or optimized for use on the capabilities of a particular type or category of communications end-point 5.

Following creation of a user interface service, the user 50 is preferably able to activate the service through some further interactive process 33 or alternatively the service management sub-system 21 may activate the service or some aspects of the service by default upon completion of the interactive process 32. In this respect, activation means the system allowing one or more of the user interfaces associated with a user interface service to be communicated to one or more communications end-points 5.

A user interface 71 is preferably communicated to a participating communications end-point 5 by means of a digital path 72,73 capable of communicating digital information between the service management sub-system 21 and the communications end-point 5 such as a data communications network or internetwork or the internet, or a PSTN or a PLMN or a Voice over IP network or inter-network or a cellular telephone network, or an SMS or MMS system, or a signalling system of a communications network, or a 3GPP or 3GPP2 IP Multimedia Subsystem or more than one of the foregoing.

In this respect, a user interface 71 may be communicated to a communications end-point 5 over a digital path 72, 73 which may already exist between the service management sub-system 21 and a communications end-point 5 should there be one, or by means of a digital path established for the purpose and if a digital path 72, 73 is so established, it may be established by the service management sub-system 21 or by the communications end-point 5 or by some other entity.

Further the communication of a user interface 71 to en communications end-point 5 may or may not make use of facilities which exist may within or be associated with a network or networks to which the communications end-point 5 or the first communications service 52, 53 is or can be associated or homed to such as network to end-point signalling capabilities or end-point to network signalling capabilities or network to network signalling capabilities or a combination of the foregoing.

### Server Push Scenarios

Methods by which a user interface 71 may be communicated to a communications end-point 5 will next be described. It is to be understood that a particular system of the present invention may incorporate one or more than one method for the provision of user interfaces to communications end-points.

The first method to be described is particularly suited to scenarios wherein a user interface 27 is be provided with a defined set of communications end-points 5 (corresponding to communications services 9). The defined set may for example correspond to potential callers to, or others of interest to, the user 50 as identified by the user 50 to the service management sub-system 21.

In this first method, a user 50 provides information sufficient to identify a network address such as an IP address of one or more communications end-points such as 5. The service management sub-system 21 then either immediately or subsequently provides the user interface 71 to the identified communications end-point 5 and perhaps also provides other user interfaces which may be efficaciously provided at that time.

Alternatively, the service management sub-system 21 may cause a signal or flag or message to be sent to the communications end-point 5 by means of SMS or IP or means involving network to end-point signalling such as SIP or ISUP, which signal or flag or message when interpreted by client software 8 on the communications end-point 5 indicates that it should send a request to the service management sub-system 21 wherein the request preferably includes end-point identification information such as a service or network addresses 9,10, and wherein the request perhaps also includes information for the service management sub-system 21 to use to determine which user interface to provide to the communications end-point 5, perhaps by means of including in the request some or all of the information contained within the signal or flag or message. The service management sub-system 21 then or subsequently preferably provides the communications end-point 5 with one or more applicable user interface 71. It is to be understood that the service management sub-system 21 may provide the communications end-point 5 with the user interface 71 over the digital path 72, 73 that the communications end-point 5 established or over a different digital path. Following receipt of the one or more user interfaces 6, client software 8 on the communications end-point 5 preferably stores them in a managed cache 7.

### Client Pull Scenarios

A second method to be described is particularly suited to scenarios wherein a user interface is to be provided for use by arbitrary potential callers, perhaps including callers who are unknown to the user 50 and who have never before communicated with the user 50.

In this second method, client software 8 on a communications end-point 5 periodically or aperiodically or in consequence of a stimulus causes the establishment of a digital connection 72, 73 to a service management sub-system 21 and the service management sub-system 21 communicates a user interfaces user interfaces or updates thereto to the communications end-point 5 by any efficacious means.

In a particularly advantageous version of this second method, during or following an inbound communication to the end-point 5 such as a voice call or SMS message, client software 8 on the communications end-point 5 retrieves identification information sufficient to identify the calling communications service such as the CLID or SIP URI, and then immediately or subsequently causes a digital connection 72, 73 to be established with the service management sub-system 21, and provides the service management sub-system 21 with some or all of the identification information, and perhaps also provides information sufficient for the service management sub-system 21 to authenticate the communications end-point 5 or client software 8 or user 1, and preferably also exchanges information sufficient for the service management sub-system 21 or communications end-point 5 to determine whether the end-point 5 already possesses a complete or up-to-date version of a user interface associated with the calling communications service if there is such a user interface; and if it does not, or in any case (and provided such a user interface exists), a copy of a current version of the user interface (for example 71) associated with the calling communications service is provided to the communications end-point 5 by the service management sub-system 21, and perhaps also copies of other user interfaces, not necessarily associated with the calling communications service which may efficaciously provided at the same time; which the client software 8 then causes to be stored on the communications end-point 5, preferably in a managed cache 7, for future use in association with calls to the calling communications service 52,53 or calls to other communications services or in other situations or at other times not necessarily in association with calls in accordance with the triggers and behaviour or behaviours encoded in the communicated user interface 27 or user interfaces.

In a beneficial variation on this particularly advantageous version of the second method, a similar process is used in the lead up to, during or following some or all outbound communications or communications attempts from a participating communications end-point 5 such as outbound phone calls or video calls or SMS messages. In this case the communications end-point 5 retrieves and forwards to the service management sub-system 21 identification information sufficient to identify the called communications service.

In a variation to the second method as applied to outbound communications particularly suited to situations where it is desired to provide user interfaces to infrequent or one-time callers, the process of checking for the availability of and retrieving a user interface commences as soon as possible following the entry on a communications end-point 5 of information sufficient to identify the communications service which is about to be called 52,53 and the user interface 27, should one exist, is expeditiously communicated to the communications end-point 5, and if communicated sufficiently quickly, immediately invoked and interpreted and if required applied to the same outbound communication (including, if appropriate, during the establishment phase of the outbound communication; during the outbound communication or following the outbound communication, wherein the interface is applied either in its intended entirety, or perhaps in part if some 74 but not all of the user interface 71 is able to be retrieved sufficiently quickly, and wherein the application of the user interface accords with behaviour explicitly encoded within the user interface 27 if any or implicitly encoded within the client software 8.

### Caching

Client software 8 on a participating communications end-point 5 preferably stores newly received user interfaces in a managed cache 7 along with other user interfaces which it may already have stored. User interfaces are preferably stored in a form which permits rapid and efficient future retrieval, perhaps through the use of an indexing or binary tree or hashing or other suitable technique or combination of techniques.

### Invocation of User Interface

A user interface 6 is preferably invoked in response to a trigger. In this respect, a user interface may be invoked by client software 8 in response to a trigger or the client software 8 may cause a user interface 6 to be invoked by other programmed logic.

In a particularly preferred embodiment of the present invention, a user interface 6 applicable to a first communications service 52,53 or user 50, is preferably invoked when client software 8 detects the pending establishment of an outbound communication to the communications service 52, 53 or user 50. The client software 8 preferably captures information sufficient to identify the communications service 52,53, or user 50 to be called and uses this information to determine whether a user interface applicable to the first communications service 52,53 or user 50 exists in the cache 7, and if it does, retrieves and invokes the cached user interface 6. In this respect, retrieval of the user interface 6 may involve steps such as unpacking, decompressing and decoding the user interface 6 or elements therein or fetching elements referenced by the user interface 6. In this respect further, interpretation of the user interface 6 may entail decoding rules or logic or directives or parameters which may be contained within the user interface 6. Invocation of the user interface 6 entails applying or acting upon one or more of the plurality of retrieved and interpreted rules or logic or directives or parameters or media elements or other elements of the user interface 6 so as induce a resultant behaviour, which behaviour preferably accords with at least some aspect of the behaviour encoded within the user interface 6.

The client sub-system 11 preferably provides a facility whereby a user 1 may at any time view or peruse or play or browse or manage user interfaces stored in cache 7, perhaps in personal address book like fashion, and wherein scrolling to or selecting a particular user interface 6 preferably triggers the invocation of some aspect of the user interface 6.

### Resultant Behaviours

A user interface 6 when invoked in response to a trigger preferably induces a resultant behaviour which accords with at least some aspect of the behaviour encoded within the user interface 6. The resultant behaviour may be directly induced by the client software 6 or the client software 6 may cause other programmed logic to induce the resultant behaviour, or both of these.

In principle there is no limit on the nature or timing or duration of the resultant behaviour or behaviours which a user interface may induce. In practice limits may be imposed by for example end-point 5 capabilities and limitations.

The resultant behaviour may vary depending upon the nature of the trigger which invoked the user interface 6. The resultant behaviour may be static or may vary dynamically in accordance with time or as a result of user input or in consequence of the occurrence of an event or events such as time events, call events, line events, network events or phone events.

The resultant behaviour invoked by a user interface 6 may change as a function of input provided by the user 1 or interaction between the user interface 6 and one or more of the plurality of the user 1 or local information or programmed logic or remote information or programmed logic 57.

The resultant behaviour induced by a user interface 6 may include establishment of an outbound communication or call. In a particularly preferred embodiment of the present invention, client software 8 preferably detects that a user wishes to initiate a communication or call to a communications service 52,53 or user 50 prior to the commencement of any call establishment process, for example, by monitoring keypad input or user activity in a Personal Address Book on the end-point 5, and invokes a user interface 6, should one be available, applicable to the communications service 52,53 or user 50 wherein the user interface 6 includes rules or logic which rules or logic which when appropriately interpreted may inter-alia cause the establishment or an outbound communication or call to the communications service 52,53 or user 50 or to another communications service or user.

A non-exhaustive list of aspects of resultant behaviours which a user interface 6 may induce includes (i) [in relation to an outbound communication or communication attempt] (ia) behaviours associated with the stage following the user's 1 input into a participating communications end-point 5 of information sufficient to identify the communications service 52,53 which is to be called or communicated with (ib) behaviours associated with the establishment of the call or communication; (ic) behaviours associated with the period during which the call or communication is connected, should there be a call and should the call be connected (id) behaviours associated with the period following the conclusion of the call or communication; (ii) behaviours associated with a user's 1 interaction with a personal address book or contacts application or call history on an end-point 5; (iii) behaviours associated with a user 1 scrolling or searching through or previewing or playing a user interface on an end-point 5; (iv) the presentation of business information or capabilities or available modes of communication or which the user 50 is willing to make available to the user 1 or users generally.

The resultant behaviour induced by a user interface 6 may include creating or changing data or information on the communications end-point 5 such as data which exists in a personal address, so that a user 50 may, for example, by establishing a user interface service, cause an entry to be made, or an existing entry updated or enhanced, in a Personal Address Book of the communications end-point 5 of a communications service that they call or communicate with (eg. send and SMS message to).

The diagrams show the communication end-point 5 and first communications service 52, 53 as being associated with the same voice communications network 81 but they may equally be associated with different voice communications networks. The diagrams show the second communication end-point 5 as being a mobile phone but it may be any suitable communications end-point equipped with the client sub-system 11.

### Exemplary Application

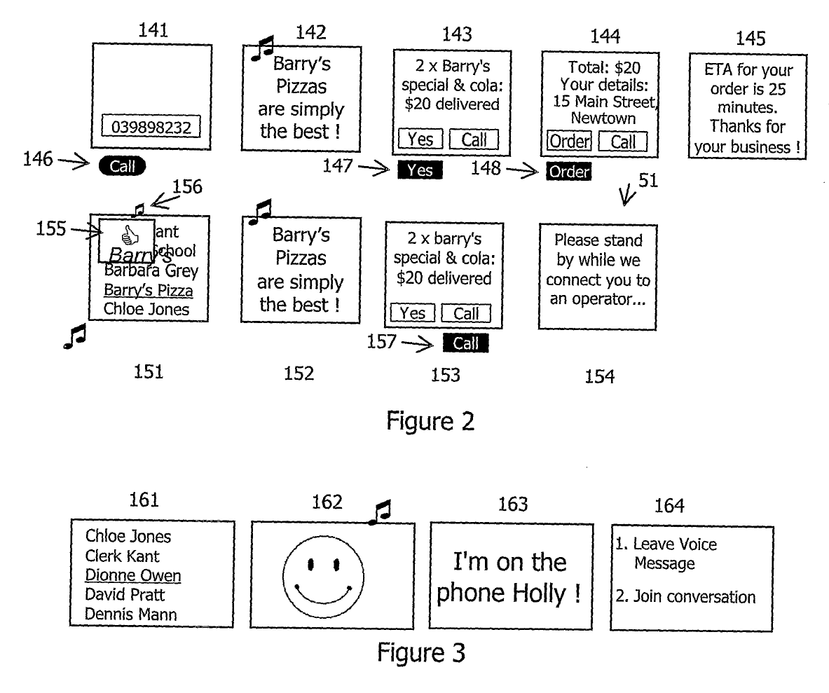

Having described aspects of resultant behaviours which may be induced by a user interface, some examples of the application of the invention will next be described. FIGS. 2 and 3, read in association with FIG. 1, illustrate the application of a user interface being used to facilitate a transaction. In FIGS. 2 and 3, if a diagram is to the right of another diagram then the event depicted in the right-most diagram occurs later in time than the events depicted in all diagrams to its left.

In this scenario, the first user 50, 54 is associated with a pizza shop while the caller 1 is an individual user with a participating communications end-point 5. The pizza shop owner has subscribed to or registered for a user interface service. The pizza shop also operates or has operated on its behalf a network accessible server system 51 (which may perhaps be World Wide Web or Web Services based), the function of which will be described in ensuing paragraphs. The network accessible server system 51 is preferably able to exchange digital information with the service management system 20.

A user 50 acting for the pizza shop establishes a user interface 27 and associates it with a communications service of the pizza shop 52, 53 in the manner described above. The user 1 may subsequently commence initiation of a call to the communications service 52, 53, by entering the phone number 52 or by selecting the pizza shop's entry from a PAB of the communications end-point 5 or by some other means. Assuming this is the user's 1 first ever call to the pizza shop, the client software 8 determines that no user interface for the first communications service 52,53 exists in cache 7 and so the call to the pizza shop proceeds as it would in a communications end-point 5 not equipped with the client sub-system 11 of this invention.

Following the conclusion of the call or call attempt, the client software 8 establishes a network connection 72, 73 to the service management sub-system 21 and provides the service management sub-system 21 with identification information including the CLID corresponding to the communications service 52, 53 just called, as well as, preferably, information which identifies the communications end-point 5 or user 1. Since there is a user interface 27 associated with this communications service 52, 53, the service management sub-system 21 communicates the user interface 27 to the communications end-point 5, which the latter stores in cache 7. The user 1 may subsequently initiate a further call to the pizza shop, perhaps by keying in the phone number 52 of the pizza shop and pressing a ‘call’ button 146.

At this point, a call is not established: rather, following depression of the ‘call’ button 146, the client software 8 traps or is provided with the called number 52; determines that there is a user interface 6 in cache 7 associated with the called number 52; retrieves the user interface 6 from cache 7 and interprets it and applies it to the outbound call as follows: a short multimedia promotional advertisement 142 is first presented to the user 1; then a menu screen 143 is presented to the user 1 inviting the user 1 with the ability to purchase the daily special if they wish to or offering them the ability to speak with an operator by pressing the ‘call’ soft-key.

In respect of the menu screen, some of the information presented such as the layout, background, graphical and audio elements, field names and lengths and information describing the default special may have been defined in the user interface 6, while other information such as the daily special and price may have been retrieved in real time from a remote information server 51 using some suitable protocol such as HTTP or SOAP. Further, some or all of the information retrieved from the remote information server 51 or some portion or derivative thereof may now be added to the user interface 6 and stored in cache 7 by the client software 8, so that the existing user interface is now updated.

We assume now that the user 1 wishes to order the daily special and so selects the ‘Yes’ soft-key 147. At this point there may now be an exchange of credentials between the client sub-system 11 and programmed logic associated with the Pizza shop's ordering system which may be located on or accessible via the server 51. An order, together with information sufficient to identify the user 1 is next communicated from the client sub-system to the Pizza shop's ordering system. The ordering system then preferably correlates the order and identification information with a customer database; accepts the order; and creates and sends a confirmation receipt to the communications end-point 5 for presentation 144 to the user 1. The user 1 then selects the ‘Order’ soft-key 148 to confirm their order. The client software 8 then causes the confirmation to be sent to the ordering system for processing.

Alternatively, the user 1 may not wish to purchase the daily special but rather may wish to speak to a human operator. The second row of diagrams 151-154 illustrates this scenario and also shows how a user interface 6 may beneficially be integrated with the behaviour of a Personal Address Book (PAB) on a communications end-point 5. When the user 1 scrolls down to and highlights the pizza shop entry in the PAB 151, invocation of the user interface 6 is triggered and the interpreted user interface 6 causes the pizza shop's logo 155 to appear on the screen 151 and perhaps also plays the pizza shop's jingle 156, the jingle and logo being media elements contained within or referenced by the user interface 6, and referenced media elements having also been fetched from their source. Subsequently, when presented with the menu screen 153, the user 1 in this case selects the ‘Call’ soft-button 157 and the interpreted user interface 6 causes a voice call 82 to be established between the communication end-point 5 and the first communications service 52, 53 or another communications service in accordance with the rules or logic contained within the user interface 6 so that the user 1 may speak with a pizza shop salesperson 54.

Some or all of the results of an invocation and application of a user interface may be used by programmed logic to create a new user interface based on the user interface 27 or user interface 6 or modify the user interface 27 or user interface 6. With reference to the current example, programmed logic on the service management sub-system 21 or the server 51 or both in cooperation may use results gleaned from their (server-side) interaction with the user 1 as mediated by the user interface 6 to construct a new user interface based on the existing user interface 6—perhaps customized to suit the particular preferences of the user 50—the new user interface being applied to a future communications between the pizza shop and this user 1, and the existing user interface perhaps continuing to be applied to communications between the pizza shop and some other users.

As can be seen, this process can continue indefinitely so that the pizza shop is able to initially establish a single user interface 6 for use with all customers which over time spawns new user interfaces which may be customised for individual users. Further, in this respect and with reference to the current example, the service management sub-system 21 or the server 51 or both in cooperation may use results gleaned from their (server-side) interaction with multiple users of the pizza shop's user interface 6 to modify the pizza shop's user interface 6 (here we refer to the version of the user interface communicated by default to all users' end-points).

Further, in this respect and with reference to the current example, in modifying or customizing the user interface 27, programmed logic within the service management sub-system 21 or the server 51 or both in cooperation may make use of information gleaned from an operator's 54 interaction with a user 1 whereby the information so gleaned is captured and entered into a computerized system and made available 55, 56 to the service management sub-system 21 or the server 20.

FIG. 3 shows what a user 50 may see in an alternative application of the system and method of the present invention oriented towards inter-personal communications. Here, a user 50 has established a user interface 27 which encapsulates some of their call handling preferences. The user interface 27 is communicated to the communications end-point 5 using one of the methods of the present invention and is subsequently triggered and invoked when the user 1 initiates a call to the communications service 52, 53 of the user 50. Thus the user 50 is able to automatically provide calling users with options for interacting with them.

Diagram 161 shows the user 1 interacting with an entry in a Personal Address Book of their communications end-point 5 to establish a call to the first communications service 52,53, thereby triggering invocation of the user interface 6; diagram 162 shows a first resultant behaviour of the invoked user interface which is the presentation of an audio-visual sequence selected or created by the user 50 at the time they established their user interface 27; diagram 163 shows a second resultant behaviour of the invoked user interface which is the presentation of a message selected or provided by the user 50 corresponding to a rule in the user interface 6 associated with a ‘line busy’ event; diagram 164 shows a third resultant behaviour of the invoked user interface which is the presentation of menu of options which accords with options the user 50 wishes to make available to this caller (who it can be presumed is a close acquaintance) in this situation and which again were encoded into the user interface 27 at the time of its establishment. The user 1 may at this point interact with the menu of options to either leave a message or join the existing conversation, or hang up.

It will be appreciated that the above-described system allows a B party to establish a ‘user interface’ which encapsulates preferred means of presenting to or interacting with A parties. This user interface can then be communicated to an A party's end-point for immediate or subsequent application to outbound calls from the A party to the B party or at other times or in other ways. Since the user interface is interpreted and displayed on the A party's communications end-point, it utilises the processing, i/o, multimedia and other capabilities of the end-point. Thus a B party is able to provide a rich call user interface to A parties by taking advantage of capabilities of A parties' end-points. Further a B party is able to provide different user interfaces to different A parties or groups of A parties.

A particular advantage of the above-described system over existing systems is that the user interface may be communicated to the A party's end-point in real time during call establishment or it may be pre-provisioned to and cached on an A party's end-point, thereby obviating network latency and intermittent connectivity issues. A further advantage of the above-described system is existing B party end-points (such as POTS phones or mobile handsets) and communications services (such as POTS services) can participate in the system unmodified.

Yet another advantage of the above-described system is participation in the system does not require the A party's and B party's end-points to home to the same switching or signalling system (for example telephone switch or PABX or VoIP server or ‘soft-switch’).

Moreover, the above-described system operates using network to end-point signalling information which is readily available to end-points such as CLID are available (however systems of the invention which take advantage of signalling or other information or resources which are only available to network operators are also available).

A still advantage of the above-described system is that a user can benefit from the operation of the system even where no voice call or communication is established. A possible outcome of the operation of the system may be that pre-call interactivity made possible by the invention satisfies the needs of a user to the extent that the need for a voice call is obviated. Further, the user interface may contain information or media or information payload which is specifically intended for off-line use by an A party.

The above-described exemplary embodiments illustrate a business and a person using the invention to control the way in which they present to and interact with others. However as should be clear, the invention may equally be used to enable users to interact with information (for example, a product) rather than a person or a business, and the interaction need not include a telephone call. Moreover, in the above-described examples the first user corresponds to the user of a first communications service, which is a communications service associated with a user interface; while the second user corresponds to the user of a second communications end-point which is a communications end-point to which a user interface is communicated for utilization.

Although a number of embodiments of the method and system of the present invention have been described, it will appreciated that there may be other variations and modifications that may be made to the embodiments described herein that will still also be within the scope of the present invention.

1. A computer-implemented method for inducing B-party defined behaviour in an A-party communications end-point, the method including the steps of:
the computer receiving a user interface at the A-party communications end-point, the user interface encoding one or more B-party defined or selected behaviours;
the computer invoking the user interface at the A-party communications end-point in response to at least one trigger; and
the computer interpreting the user interface at the A-party communications end-point to induce a resultant behaviour.

2. A method according to claim 1, wherein the A-party communications end-point is a mobile phone, a fixed network phone, a SIP phone, a VoIP phone, a soft phone, a PC based communications client, or an Instant Messaging client.

3. A method according to claim 1, wherein the trigger is any one or more of the following:
an event associated with an outbound communication or attempted establishment of an outbound communication by the A-party communications end-point;
an event which is a precursor event to the establishment or attempted establishment of an outbound communication by the A-party communications end-point;
entry of information on a keypad or keyboard of the A-party communications end-point; and
entry of one or more than one keystroke in succession on a keypad or keyboard of the A-party communications end-point.

4. A method according to claim 3, wherein the outbound communication or communication attempt includes any one or more of the following:
a telephone call;
a voice over Internet Protocol call;
a video call;
a multi-mode call;
an SMS message;
an MMS message;
an Instant Message; and
an email.

5. A method according to claim 3, wherein the outbound communication or communication attempt is an outbound communication or communication attempt from the A-party communications end-point to a B-party user.

6. A method according to claim 3, wherein the event or precursor event is any one or more of the following:
the selection of the user interface or of some aspect of the manifestation of an interpreted user interface;
the initiation of a communication on the A-party communications end-point such as by depression of a call key or soft key or equivalent action;
the entry of at least part of a telephone number on the A-party communications end-point; and
the selection of an entry in an address book or call history on the A-party communications end-point.

7. A method according to claim 3, wherein the resultant behaviour commences:
prior to the establishment of the outbound communication;
during the establishment of the outbound communication;
during the outbound communication; or
following the conclusion of the outbound communication.

8. A method according to claim 7, wherein the resultant behaviour, having commenced, persists:
during part or all of the outbound communication; or
beyond the conclusion of the outbound communication.

9. A method according to claim 1, and further including the steps of:
storing the user interface at one or more network accessible locations; and
communicating the user interface to the A-party communications end-point in response to a stimulus.

10. A method according to claim 9, wherein the user interface includes more than one part, and the parts are stored at more than one network accessible location.

11. A method according to claim 9, wherein the user interface is:
established at one or more of the network accessible locations; or
uploaded to one or more of the network accessible locations.

12. A method according to claim 9, wherein more than one user interface is associated with the B-party user and none, one or more than one of the plurality of associated user interfaces is communicated to a A-party communications end-point for use on the A-party communications end-point according to any one or more of the following:
preferences or rules provided by or on behalf of a user, subscriber or controller of the B-party user or a communications service used by the B party;
information communicated from the A-party communications end-point;
an identifier or network address or service address or end-point address of the B-party user or the communications service used by the B party or a B-party user end-point;
an identifier or network address or service address or end-point address of the A-party user or a communications service used by the A party or the A-party communications end-point;
capabilities of the A-party communications end-point;
the time or date;
the geographic location of the A-party communications end-point; and
programmed logic.

13. A method according to claim 9, wherein the user interface is adapted to be modified or updated or replicated consequential to the interpretation of any one or more of the following:
information local to one or more of the network accessible locations;
information communicated to one or more of the network accessible locations;
information communicated to one or more of the network accessible locations from the A-party communications end-point;
information which derives from a previous communication between the A-party communications end-point and the B-party user or one or more communications services used by the B-party;
information which is the result of previous communications between a A-party communications end-point and one or more of the network accessible locations;
information local to the A-party communications end-point;
information communicated to the A-party communications end-point;
information communicated to the A-party communications end-point from one or more of the network accessible locations;

14. A method according to claim 9, wherein the user interface is stored on an A-party communications end-point.

15. A method according to claim 14, wherein the user interface is stored:
ephemerally;
for a defined period of time or a period of time determined by programmed logic;
until such time as a newer version is available;
until deleted in accordance with a user action; or
indefinitely.

16. A method according to claim 9, wherein the stimulus originates:
on the A-party communications end-point; or
at one or more of the network accessible locations.

17. A method according to claim 9, wherein the stimulus is:
the completion of the storing of the user interface at one of the network accessible locations;
a request from programmed logic on the A-party communications end-point; or
invocation of the user interface on the A-party communications end-point.

18. A method according to claim 17, wherein the request includes information capable of identifying at least one B-party user or a communications service used by the B-party or a B-party end-point with which the user interface is associated.

19. A method according to claim 9, wherein the stimulus is the communication to one or more network accessible location of an event associated with a communication or communication attempt from:
the B-party user or communications end-point; or
the B-party user or a communications service used by the B party to the A-party communications end-point; or
the A-party user or communications end-point; or
the A-party user or communications end-point to the B-party user or a communications service used by the B-party.

20. A method according to claim 9, wherein the communicating of the user interface to the A-party communications end-point commences during establishment of an outbound communication or communication attempt from the A-party communications end-point and proceeds in real-time.

21. A method according to claim 20, wherein the user interface, once communicated to the A-party communications end-point, is immediately invoked and interpreted thereon.

22. A method according to claim 21, wherein a part of the user interface communicated to the A-party communications end-point is immediately invoked and interpreted thereon.

23. A method according to claim 9, wherein the communicating of the user interface to the A-party communications end-point occurs following the provision to one or more of the network accessible locations of information sufficient to enable identification of address information to allow communication of the user interface from one or more of the network accessible locations to the A-party communications end-point.

24. A method according to claim 9, wherein the user interface, prior to invocation, is retrieved from storage on the A-party communications end-point, the retrieval step involving a process of searching on the A-party communications end-point for the correct or best or most appropriate user interface to be used in a particular circumstance or in response to a particular trigger.

25. A method according to claim 9, wherein the resultant behaviour occurs in one or more of the following locations:
on the A-party communications end-point;
on a sub-system or associated system of the A-party communications end-point; or
at a location other than the A-party communications end-point.

26. A method according to claim 9, wherein the resultant behaviour is influenced by interaction between the user interface on the A-party communications end-point and one or more of the following:
a user input;
one or more locally detectable events or associated parameters;
local or remote information or programmed logic;
another copy or version of the same user interface;
a part of the same user interface located elsewhere;
another user interface;
an end-point associated with the B-party user; and
a communications service associated with the B-party user

27. A method according to claim 9, wherein the resultant behaviour varies depending upon the nature of the trigger which invoked the user interface.

28. A method according to claim 9, wherein the form, nature or duration of the resultant behaviour varies dynamically in response to changes in call status, line status, end-point, phone, network, signalling events or associated parameters.

29. A method according to claim 9, wherein the resultant behaviour includes one or more of the following:
the presentation of one or more of a plurality of static or dynamic or streaming or interactive media elements;
programmed physical movement;
establishing an outbound communication; and
creating or changing data or information.

30. A method according to claim 29, wherein the changed data is:
data associated with a personal address book of the A-party communications end-point; or
data associated with a call history of the A-party communications end-point.

31. A method according to claim 12, wherein the communications service used by the B-party is any one or more of the following:
a telephone service;
a voice over IP service;
an Instant Messaging service;
a video phone service; and
a video-conferencing service.

32. A computer readable medium having instructions stored thereon that when prosecuted by a processor are effect to cause said processor to implement a user interface for inducing B-party defined or selected behaviour in an A-party communications end-point, the user interface encoding one or more B-party defined behaviours and including one or more software or data objects to cause:
invocation of the user interface at the A-party communications end-point in response to one or more triggers; and
interpretation of the user interface at the A-party communications end-point to induce a resultant behaviour.

33. A medium according to claim 32, wherein an association between the user interface and the B-party user or a communications service used by the B party is encoded within the user interface.

34. A medium according to claim 33, wherein the user interface is associated with more than one B-party user or communications service.

35. A medium according to claim 32, wherein the user interface is established for a B-party user or a communications service used by the B party which is not otherwise associated with a user interface.

36. A medium according to claim 32, wherein the user interface includes by means of incorporation, or specifies by means of reference, one or more of the following:
static or dynamic or streaming or interactive media objects or software objects;
media objects which contain plain or formatted text or audio or visual or video or animated media;
computer files or executable or interpretable code or scripts;
data which represents logic, rules, preferences or digital rights;
data elements which encode the layout or presentation of or control the timing of or behaviour of media objects or software objects;
control or data elements which associate media objects with actions or events; and
data or code or script which may be of use in presenting the resultant behaviour.

37. A medium according to claim 32, wherein the user interface encodes application specific, generic or default behaviours.

38. A system for inducing B-party defined behaviour in an A-party communications end-point, the system including:
one or more network accessible entities configured to:
store a user interface encoding one or more B-party defined or selected behaviours; and
communicate the user interface to the A-party communications end-point; and
at least one A-party communications end-point configured to:
receive the user interface;
invoke the user interface in response to one or more triggers; and
interpret the user interface to induce a resultant behaviour.

39. A system according to claim 38, wherein the A-party communications end-point is configured to:
cache or store user interfaces;
retrieve user interfaces; and
manage stored or cached user interfaces.

40. A system according to claim 39, wherein the one or more network accessible entities store pre-made user interfaces or interface elements for selection and use as, or incorporation into, new user interfaces.
